(19) United States
(12) Patent Application Publication
(10) Pub. No.: US 2002/0176450 A1
(43) Pub. Date: Nov. 28, 2002

(54) System and methods for selectively transmitting ethernet traffic over SONET/SDH optical network

(75) Inventors: Thomas Leonard Kong, Brookline, MA (US); Naimish Patel, North Andover, MA (US); Yang Cao, Chelmsford, MA (US)

Correspondence Address: LAHIVE & COCKFIELD, 28 STATE STREET, BOSTON, MA, 02109, US

(73) Assignee: Sycamore Networks, Inc., Chelmsford, MA

(21) Appl. No.: 10/000,497

(22) Filed: Oct. 31, 2001

Related U.S. Application Data
(60) Provisional application No. 60/265,393, filed on Jan. 31, 2001.

(51) Int. Cl. H04L 12/28; H04L 12/56

(52) U.S. Cl. 370/539; 370/397; 370/401

(57) ABSTRACT

An interface for an optical node with a plurality of input ports and output ports in SONET/SDH optical network connected to a plurality of virtual concatenation channels has a plurality of input ports for taking Ethernet signals as inputs, and a plurality of output ports for selectively outputting Ethernet frames in the Ethernet signals to the virtual concatenation channels. A method classifies the Ethernet input pipes in a SONET/SDH network with a plurality of virtual concatenation channels, and allocates the classified packets onto the virtual concatenation channels.

### CROSS REFERENCE TO RELATED APPLICATIONS

Not Applicable.

### STATEMENT REGARDING FEDERALLY SPONSORED RESEARCH

Not Applicable.

### REFERENCE CITED

1. T1X1.5/99-204, T1.105.02 draft text for Mapping IEEE 802.3/Ethernet MAC frames to SONET payloads, T1X1.5 Meeting, Jul. 26-29, 1999

2. T1X1.5/2000-024R5, Generic Framing Procedure (GFP)

### FIELD OF THE INVENTION

The present invention relates generally to SONET (Synchronous Optical Network)/SDH (Synchronous Digital Hierarchy) optical network and more particularly to system and methods for selectively transmitting Full Duplex Ethernet traffic over SONET/SDH networks.

### BACKGROUND OF THE INVENTION

The present invention relates to the transport of packet traffic, more particularly Ethernet traffic in optical communications networks employing synchronous signaling techniques, such as networks employing SONET or SDH signaling formats.

The SONET/SDH standards were engineered to create a highly reliable, synchronous, high-speed networking scheme that leverages the power of fiber optic technology. SONET/SDH is highly regarded by traditional carriers because of its predictability and ease of management. It is well designed for handling TDM (Time Division Multiplexing)-based voice traffic reliably throughout a worldwide network. The SONET frame provides a convenient standard mechanism to multiplex and transport circuit-switched traffic in high-speed backbones. SONET also provides mechanisms to support network functions such as error detection, alarm insertion, automatic protection switching, etc. The common frame format also allows for advanced functions, such as electro-optic switching, signal regeneration, internal signaling, and signal restoration, that are independent of the format of the native traffic carried by the network. Because of these and other beneficial characteristics, SONET/SDH based networks have been adopted by service providers as the backbone technology of choice for addressing ever-increasing bandwidth demands. While SONET/SDH remains a widely used and important standard, the explosion of data traffic in the public network has highlighted some of the serious problems associated with the SONET/SDH approach to transporting data traffic efficiently.

As said, the existing SONET/SDH transport structures are sufficiently optimized to support traditional TDM (time division multiplexing) voice type applications, they are glaringly bandwidth inefficient when confronted with the inherently bursty, variable-size and statistical characteristics of data applications. New applications requiring transport in SONET/SDH concatenated payload envelopes run the risk of being unsupported by traditional coarse SONET rates (e.g. SONET STS-2c, STS-4c, STS-24c or SDH VC-2-2c) in a low level such as STS-1 or even VT 1.5.

Virtual concatenation (VC) is a procedure whereby a multiplicity of Virtual Containers is associated one with another with the result that their combined capacity can be used as a single container across which bit sequence integrity is maintained. VC is a byte level inverse multiplexing technique, it has the characteristics of right sized bandwidth, improved granularity, cost, low delay, low jitter, re-use of protection bandwidth and high efficiency payload mapping.

Carriers need to move to a just-in-time investment and service delivery model, introducing/expanding services such as Bandwidth On Demand (BOD) when and where needed in response to demand so to manage the frequently unpredictable demand of data traffic. In responding to this demand, Intelligent Optical Networking, a flexible, highly scalable optical network architecture for the delivery of public network services, provides an innovative and practical solution to network scaling and high-speed service delivery issues, which brings intelligence and scalability to the optical domain by combining the functionality of SONET/SDH, the capacity creation of DWDM (Dense Wavelength Division Multiplexing) and innovative networking software into a new class of optical transport, switching and management products.

Many packet-switched local area networks (LANs) use framing that is defined in the long-established Ethernet standard. Unlike SONET, Ethernet and other LAN protocols rely on non-synchronous signaling techniques. Gigabit Ethernet (GbE) is an evolution of the Ethernet LAN standard to gigabit rates. It uses the same frame format specified by the original Ethernet standard including full duplex. GbE also employs the same variable frame length (64-1518 byte packets) specified in the Ethernet and Fast Ethernet standards. This backward compatibility makes it easier to connect existing lower-speed Ethernet devices to GbE devices using LAN switches and routers for speed adaptation. Ethernet is simple to use, inexpensive, and features exceptional scalability and high performance. In addition, Ethernet is a dominant technology in LANs.

Ethernet enables service providers to leverage the networking intelligence and scalability of the Intelligent Optical Network to address a broad range of IP-centric application needs, including transparent LAN interconnect, VLAN(Virtual LAN), GbE private lines for backbone routers/switches, and high-speed optical network access. This new class of services couple Ethernet technology with the Intelligent Optical Network, where scalability, capacity and restoration provide the foundation for true carrier-class performance. VLAN based on IEEE's 802.1Q standard was developed to address the problem of how to break large networks into smaller parts so broadcast and multicast traffic wouldn't grab more bandwidth than necessary. The 802.1Q specification establishes a standard method for inserting virtual LAN (VLAN) membership information into Ethernet frames: a VLAN tagged frame where VLAN ID and Priority info is inserted. The standard also helps provide a higher level of security between segments of internal networks. 802.1Q VLANs aren't limited to one switch. VLANs can span many switches, even across WAN (Wide Area Network) links. Sharing VLANs between switches is achieved by inserting a tag with a VLAN identifier (VID) into each frame. A VID must be assigned for each VLAN. By assigning the same VID to VLANs on switches, one or more VLAN (broadcast domain) can be extended across a large network.

Because SONET and Ethernet have been separately optimized for transport and data networking, respectively, the existing art has treated these signaling mechanisms in an isolated manner. Many efforts, such as Packet over SONET, have tried to bring Ethernet and SONET/SDH together so to leverage the advantages of both and close the gap between them. A proposal for mapping of Ethernet frames into SONET/SDH paths using byte oriented High-level Data Link Control (HDLC) frame encapsulation has been made in [1]. Another proposal for carrying Ethernet MAC (Media Access Control) frames over SONET in either point-to-point or ring topologies using Generic Framing Procedure (GFP) was made in [2] The current technologies like GFP and VC enable Ethernet service to be transported over SONET network to leverage Ethernet's rich service model, easy provisioning and SONET network's reliability.

### SUMMARY OF THE INVENTION

It would, therefore, be desirable to provide SONET/SDH optical networks system and methods for selectively carrying Ethernet signals by classifying the packets in Ethernet signals and mapping the classified packets to virtual concatenation channels so to provide different COS (Class Of Service) to the clients. This is particularly advantages in the presence of SONET switching as part of the system solution In accordance with the present invention, methods and apparatus are disclosed to selectively carry Ethernet signals over a SONET/SDH network.

An interface for an optical node with a plurality of input ports and output ports in a SONET/SDH optical network connected to a plurality of virtual concatenation channels has a plurality of input ports for taking Ethernet pipes as inputs, and a plurality of output ports for selectively outputting Ethernet frames in the Ethernet pipes to the virtual concatenation channels.

A method that classifies the Ethernet input pipes in a SONET/SDH network with a plurality of virtual concatenation channels, and allocates the classified packets onto the virtual concatenation channels.

### BRIEF DESCRIPTION OF THE DRAWINGS

The invention will be more fully understood from the following detailed description taken in conjunction with the accompanying drawings, in which:

FIG. 1 is a block diagram illustrating the extending GbE LANs over a SONET/SDH network in the illustrative embodiment.

FIG. 2A shows an Ethernet MAC frame.

FIG. 2B shows a GFP frame format with linear extension.

FIG. 2C shows the definition of a User Payload Identifier.

FIG. 3 shows a function block diagram of Ethernet to VC interface in accordance with the illustrative embodiment of the present invention.

FIG. 4A shows a VLAN tagged Ethernet MAC frame with VLAN ID and priority field (Tag control).

FIG. 4B shows an IEEE 802.1Q tag type in more detail.

FIG. 5 shows an implementation of link layer to PHY layer based on SPI4.2.

FIG. 6A shows a double tagged Ethernet frame with a VCL (Virtual Channel Label) byte.

FIG. 6B shows derivation of SPI channel number and secondary label

FIG. 7 illustrates an example of direct GbEs to VC channel mapping in accordance with the illustrative embodiment of the present invention

FIG. 8 illustrates an example of aggregation of multiple GbEs to a single VC channel in accordance with the illustrative embodiment of the present invention

FIG. 9 illustrates an example of aggregation of multiple GbEs to multiple VC channels in accordance with the illustrative embodiment of the present invention

FIG. 10 illustrates an example of point to multipoint application of GbE over SONET in accordance with the illustrative embodiment of the present invention

FIG. 11 illustrates an example of selective protection service in accordance with the illustrative embodiment of the present invention.

### DETAILED DESCRIPTION OF THE INVENTION

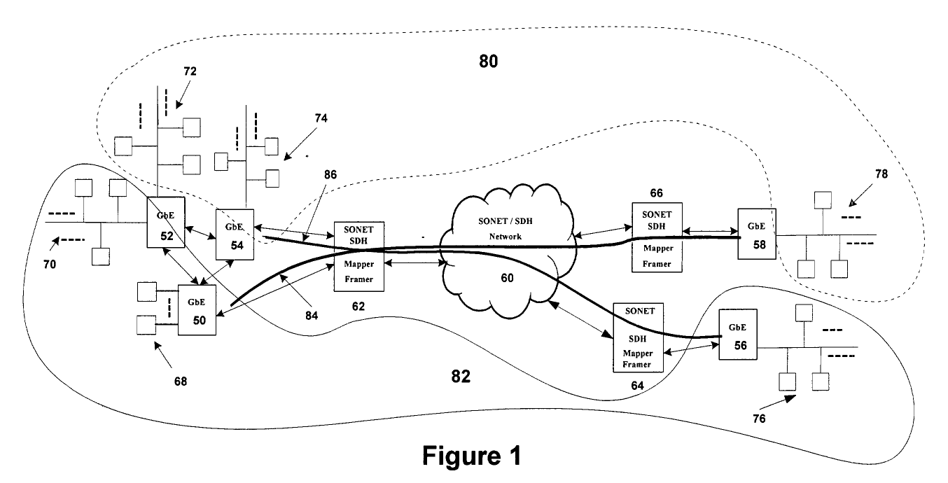

FIG. 1 shows a conventional way of sending GbE over SONET/SDH backbone network which interconnects multiple LANs 68, 70, 72, 74, 76 and 78, where each LAN has a plurality of hosts connected to it. The traffic flow is controlled by GbE routers/switches 50, 52, 54, 56 and 58. The LANs traffic from the plurality of hosts on one side are sent over SONET/SDH backbone network 60 via edge GbE router/switch 50 and 54 to the other side LANs via two SONET circuits 84 and 86. The traffic is received on the other side LANs via the edge GbE router/switch 56 and 58 and distributed to the plurality of hosts.

As is known in the art, when the GbE traffic is sent to SONET/SDH network, the GbE MAC frames are first mapped into a frame with an appropriate structure and then mapped to SONET payload. The detailed mapping procedure is as follows.

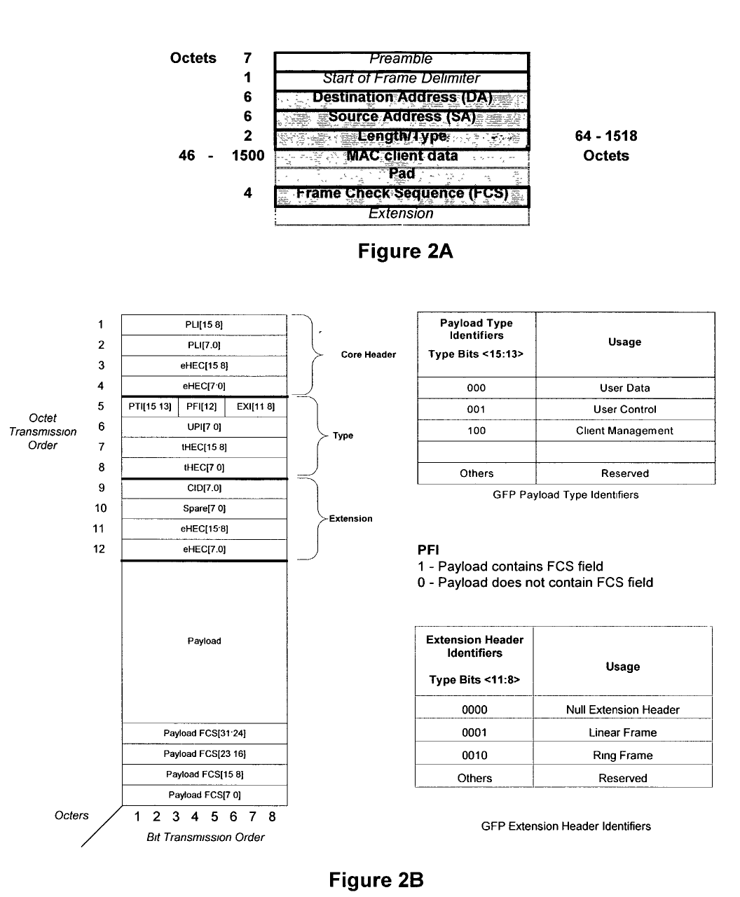

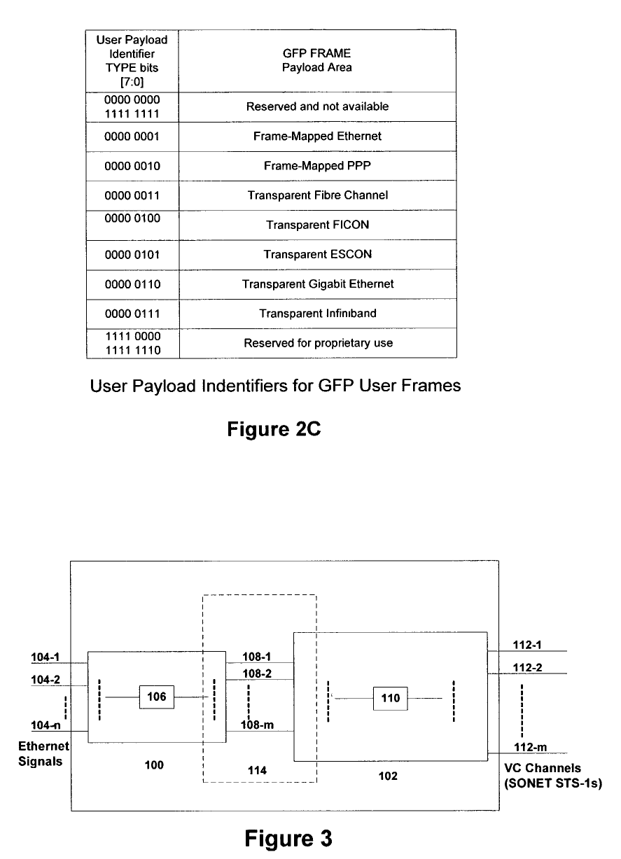

FIG. 2A shows an Ethernet MAC (Media Access Control) frame. The MAC layer uses its Frame Check Sequence (FCS) to determine the integrity of the relevant MAC layer information. The Ethernet FCS is calculated over the octets from Destination Address (DA) to the Pad inclusive. From the MAC-layer information-content point-of-view, the meaningful part of the frame consists of the octets from the Destination Address to the FCS fields inclusive. This is the shaded region of FIG. 2A. The extension field is only used for 1000 Mb/s half-duplex operation. The preamble and SFD fields are used, in conjunction with the 12-octet-equivalent Inter-Frame Gap (also called Inter-Packet Gap), for Ethernet frame delineation. The shaded region is also the region to which the 64 to 1518 octet frame length limits apply. Since this is the region of the Ethernet MAC frame that contains the relevant MAC layer information, this is the region that must be transferred intact by the Physical layer.

Ethernet can be sent over SONET network in a couple of ways, such as POS (Packet over SONET) and GFP. To use POS, an Ethernet frame is first mapped into a HDLC frame, which has the problems of throughput performance as was raised in [1]. In contrast, GFP can be used to carry Ethernet MAC frames over SONET in either point-to-point or ring topologies. This enables Ethernet LAN service to be carried on the SONET transport network directly.

FIG. 2B shows a GFP linear frame format and corresponding mapping of Ethernet MAC frame into the payload. Although there are various type of GFP frame, only a Linear frame is shown here for illustration purpose. The GFP frame header is divided into core header and extended header. The Core header is a generic header that redefines the 802.3 preamble and SFD fields from the MAC layer. The header includes:

Length field (2 bytes) to identify the length of the overall frame for delineation.

Type field (2 byte) to identify the MAC frame payload type and the extended header type.

Core header error check (cHEC—2 bytes) is a CRC (Cyclic Redundancy Check)-16 over the proceeding 8 bytes of the core header. It is used for delineation.

Type header error check (tHEC—2 bytes) is a CRC (Cyclic Redundancy Check)-16 over the proceeding 2 bytes of the type header. It is used for delineation.

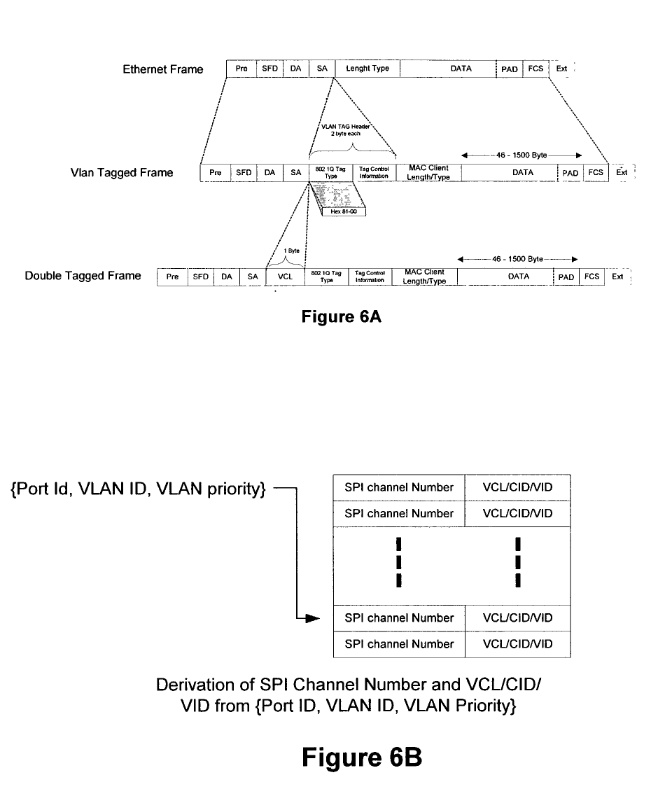

Referring back to FIG. 1, when sending Gigabit Ethernet Packets over SONET, a line interface on an edge SONET node containing SONET framer such as 62, 64 and 66 in FIG. 1 will terminate the Gigabit Ethernet packets with a MAD (Medium Access Device) along with Clock and Data Recovery (CDR) and serializer/deserializer (SerDes). The Ethernet packets are then encapsulated within a type of frame format such as POS or GFP. GFP will be used in this illustration. Only the core header is sufficient to delineate one packet from another. The extension field is not needed for a point to point connection, since all packet arriving at the remote site is sent out to only one port. However, in the case of multiple ports within a remote site, secondary information is required to identify the port id. One method is to use the extension header of GFP (FIG.2C) or add a secondary outer tag such as Virtual Channel Label (VCL) or VLAN ID as shown in FIG. 6. For illustration purpose, following mapping steps shows how an Ethernet packet is transported across the SONET network referring to FIG. 1 from 62 to 66 using GFP linear frame extension. A double tag using VCL or VLAN tag is also possible but not illustrated here:

Encapsulate the MAC frame using the GFP frame format per FIG. 2B. This involves with:

Calculation of the length of the frame including the encapsulation header fields.

Filling the payload type (PTI) value as the “User Data.”

Filling the extension header identifier (EXI) as “Linear Frame.”

Filling the User Payload Identifier (UPI) as “Frame-Mapped Ethernet”

Filling the CID of the extension header with the remote port id

Header error check algorithm for the core header and the extended header.

If PFI file is set to 1, add the 32 bit FCS field to the end of the GFP frame.

Map the frame to the NxSTS-1 payload.

To support any bit rate of Ethernet service in SONET point-to-point or ring topologies, SPE (Synchronous Payload Envelope) sizes are selected to provide the most efficient use of the SONET bandwidth using virtual concatenation.

The original tributary bit rates chosen for SONET/SDH were intended for voice services. These rates have a coarse granularity, require duplicate network resources for protection and are not a good match to LAN bandwidths. The bandwidth links supported by SONET/SDH without VC are listed below:

| SONET | SDH |
|---|---|
| DS1 (1.5 Mbit/s) | E1 (2 Mbit/s) |
| DS3 (45 Mbit/s) | E3 (34 Mbit/s) |
| STS-3c (150 Mbit/s) | STM-1 (150 Mbit/s) |
| STS-12c (620 Mbit/s) | STM-4 AU-4-4c (620 Mbit/s) |
| STS-48c (2.4G bit/s) | STM-16 AU-4-16c (2.4 Gbit/s) |

Bit rates for Transparent LAN Services are typically 10 Mbit/s and 100 Mbit/s. Bit rates of 1 Gbit/s are also becoming more and more popular. Other services (e.g. ATM cells stream) may vary from a few Mbit/s to several tens of Mbit/s. However there are no direct mappings for the transport of such bit rates over SONET/SDH. In order to transport the services mentioned above via a SONET/SDH transport network there is no match in the bandwidth granularity.

With virtual concatenation, the following additional bandwidth links would be available:

| SONET | SDH |
|---|---|
| VT-1.5 (1-84) 1.6 Mbit/s-134 Mbit/s | VC-12 (1-63) 2.2 Mbit/s- |
| | 137 Mbit/s |
| STS-1 (1-64) 49 Mbit/s-3.1 Gbit/s | VC-3 (1-64) 49Mbit/s-3.1 Gbit/s |
| STS-3c (1-64) 150 Mbit/s-10Gbit/s | VC-4 (1-64) 1 50 Mbit/s- 10Gbit/s |

Following table shows the bandwidth efficiency with and without VC when SONET carries various popular bit rates:

| Bit rate | Without | With |
|---|---|---|
| 10 Mbit/s | STS-1 (20%) | VT-1.5-7v (89%) |
| 25 Mbit/s | STS-1 (50%) | VT-1.5-16v (98%) |
| 100 bit/s | STS-3c (67%) | STS-1-2v (100%) or VT-1.5-63v (99%) |
| 200 Mbit/s | STS-12c(33%) | STS-1-4v (100%) or STS-3c-2v (66%) |
| 1G bit/s | STS-48c(42%) | STS-3c-7v (95%) |

VC offers right sized bandwidth, improved granularity, cost, low delay, low jitter, re-use of protection bandwidth and high efficiency payload mapping.

Referring back to FIG. 1, the nomenclature used is as followed. Network VLAN segment is identified by number with underscore. This is the VLAN that span across the Ethernet and SONET network. Ethernet terminating equipment connections to SONET network are identified by bold number. The local VLAN that span within a local Ethernet segment is identified by an italicized number. In FIG. 1, there are two network VLANs 80 and 82 used for the purpose of easy management, bandwidth efficiency for broadcast and multicast traffic and security between segments of internal networks. As shown in FIG. 1, the traffic sent over to SONET via GbE router/switch 54 may contain packets from different local VLANs such as 72, 70 which may belong to different network VLANs 80 and 82. Since the mapping from GbE pipes 50, 54 to the SONET circuits 84, 86 is one-to-one conventionally, VLAN and COS services to the clients will be hard to provide due to this nature of traffic mix. The packets from different clients with different VLAN and COS requirements can not be separated so to be treated differently. For example, the packets from GbE ports 54 which may contain traffic from LAN 72 that actually belongs to VLAN 80 will be also sent to GbE port 56 that belongs to network VLAN 82, which is 1) bandwidth inefficient since hosts in local VLAN 76 will have to process and reject the packets from local VLAN 72 and 2) not secure since packets from local VLAN 72 which is part of network VLAN 80 is not intended to be sent to local VLAN 76 which is part of network VLAN 82. Another closely related issue is that for the two GbE pipes from 50 and 54 each with rate 1 Gbit/s, two SONET circuits 84 and 86 with equal bandwidth 1 Gbit/s have to be provisioned. It is more economical if some VC channels with much smaller bandwidth, such as at the STS-1 to STS-12 levels, are provisioned to transmit the packets from 50 and 54 which may contain traffic from different clients with different COS requirements and adjust the VC channel bandwidth accordingly by taking advantage of finer granularity provided by VC and the bursty nature of data traffic.

FIG. 3 shows the functional block diagram of an Ethernet to VC interface in accordance with the illustrative embodiment of the present invention. The functionality of the interface is to take a plurality of Ethernet signals 104-1, . . . 104-n as inputs, terminate and process the Ethernet signals, and map them into SONET VC channels 112-1, . . . 112-m which can have bandwidth as low as STS-1 or even VT-1.5. Although there are many ways of implementing the proposed interface, for illustrative purposes, the functionality of the proposed interface can be further divided into two main blocks 100 and 102. Block 100 takes Ethernet signals, classifies the packets in the Ethernet pipes, and allocates the packets onto a plurality of channels 108-1, . . . 108-m. Block 102 maps the packets on channels 108-1, . . . 108-m into SONET payload and allocate them onto VC channels 112-1, . . . 112-m. Block 100 includes a mapping mechanism 106 which has the basic functionality of terminating the Ethernet line coding, to use GbE as example for illustrative purposes, 106 will also encapsulated the Ethernet frame with GFP frame. An extension header is used or a double tagged method of the Ethernet frame using VCL or VLAN tag (see FIG. 6). When double tagging is employed, the Ethernet FCS is recalculated. The encapsulated GFP frame is then mapped onto multiple channels 108-1, . . . 108-m.

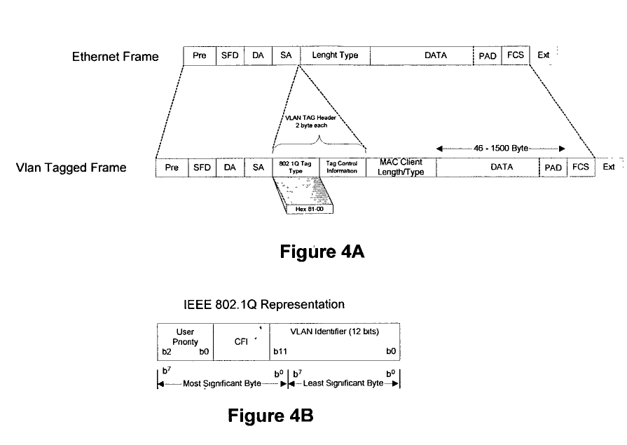

There are plurality of ways of classifying and allocating the packets in the Ethernet pipes. As shown in FIG. 4A, the VLAN ID and priority information can be used to provide VLAN service and COS services. FIG. 4A shows a tagged Ethernet MAC frame with VLAN ID and priority field (Tag control). FIG. 4B shows the 802.1Q tag type in more detail. Higher layer information such as MPLS (Multiprotocol Label Switching) routing information can also be used along with the frame carried control information for the same packet classification purpose.

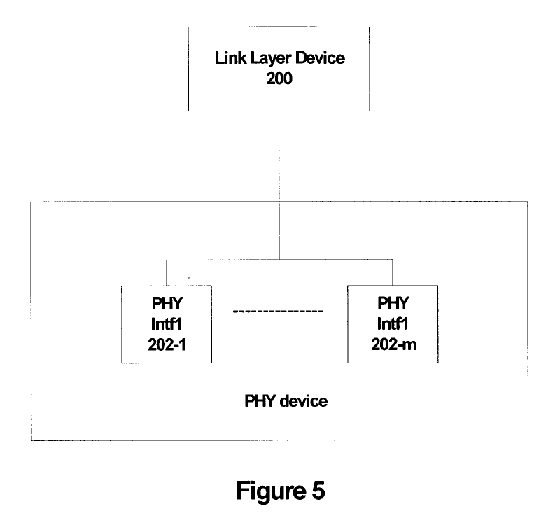

Block 102 includes another mapping mechanism which has the basic functionality of mapping packets on each channel 108-1, . . . 108-m into SONET VC payload and allocating them to VC channel 112-1, . . . 112-m in an one-to-one fashion. The mapping from Ethernet to SONET VC channels actually is a mapping from link layer to PHY (Physical layer). It will be beneficial for interoperability to implement a standard interface 114 between 100 and 102 to interconnect a link layer entity to channelized physical interfaces, which mare further connected to VC channel ports. SPI4.2 (System Physical Interface Level 4) from OIF (Optical Internetworking Forum) or UTOPIA (The universal test and operations physical interface for ATM) from ATM forum can be used for this purpose. FIG. 5 shows an implementation for 114 based on SPI4.2, where a link layer device 200 such as 50, 54 in FIG. 1 connects to a PHY device such as a SONET optical switch node with a plurality of PHY interfaces (such as SONET VC Channel ports) 202-1, . . . 202-m. The basic interface is a 32-bit data bus operating up to 415 MHz. In addition to data, the only other signals are a clock and a ctrl signal; the latter indicates whether a data or control word is being transferred. Flow control, addressing and other control functions are all performed by control transfers over the data bus. It provides addressing support for payloads channelized down to STS-1 with addressing support for even deeper channelization such as VT 1.5.

The mapping mechanisms in FIG. 3 works for traffic flowing in both directions. The key for the inverse mapping from SONET payload to Ethernet ports is to map SONET signal correctly to a Ethernet port. As shown in FIG. 2B, this information is in a GFP frame when GFP is used to carry Ethernet over SONET. If other framing technology, such as HDLC, is used, a VCL (Virtual Channel Label) byte can be inserted into Ethernet frame to carry the required port address information as shown in FIG. 6A. The method used to derived SPI channel number 108-1, . . . 108-m is illustrated in FIG. 6B. The input to the variable should be client port id, VLAN ID and VLAN priority. An example to use the above mentioned variable as index to a table that will provide the channel number (FIG. 6B shows this as SPI Channel Number). This same method should be used to obtain CID (Channel ID) for the extension header or VCL or double VLAN ID to determine the remote port id.

SONET is a circuit switched network in nature which is different from IP datagram networks in many ways, which restricts the applicability of many IP based service models to SONET network. The present invention will help alleviate such problems.

Among the major difference between routing for SONET (circuit switched networks) and IP (packet switched networks), is the end to end connection SONET circuit switched that must be explicitly established based on network topology and resource status information. This topology and resource status information can be obtained via routing protocols such as OSPF (Open Shortest Path First). But the routing protocols in the circuit switched case are not involved with data (or bit) forwarding, while in the IP packet switched case the routing protocols are explicitly involved with data plane forwarding decisions and hence impact service. So for SONET networks, topology and resource status inaccuracies will affect whether a new connection can be established (or a restoration connection can be established) but will not (and should not) cause an existing connection to be torn down.

For SONET network path selection, any information that can potentially aid in route computations or be used in service differentiation may be incorporated into the routing protocol, as either a standard element or a vendor specific extension. A route computation algorithm will use this information to compute an optical route. The optical route computation problem is really a constraint-based routing problem that occurs, for a given connection, in a single network element, for example, an optical switch node. Due to the fact that clear, hard blocking prevails in the optical world while some level of overloading is acceptable in the IP world, statistical multiplexing is not available with optical circuits. The protection between circuit switched network and packet-based network is also quite different. In a packet-based network although the protection path can be setup prior to any fault, the resources along the protection path are not used until the failure occurs. In circuit-based networks a protection path generally implies a committed resource which restricts the direct applicability of some of the traffic engineering mechanisms used in a packet-based network to a circuit-based network.

The invention can now be better understood by consideration of the following specific examples which demonstrate the characteristics of the present invention:

### EXAMPLE 1

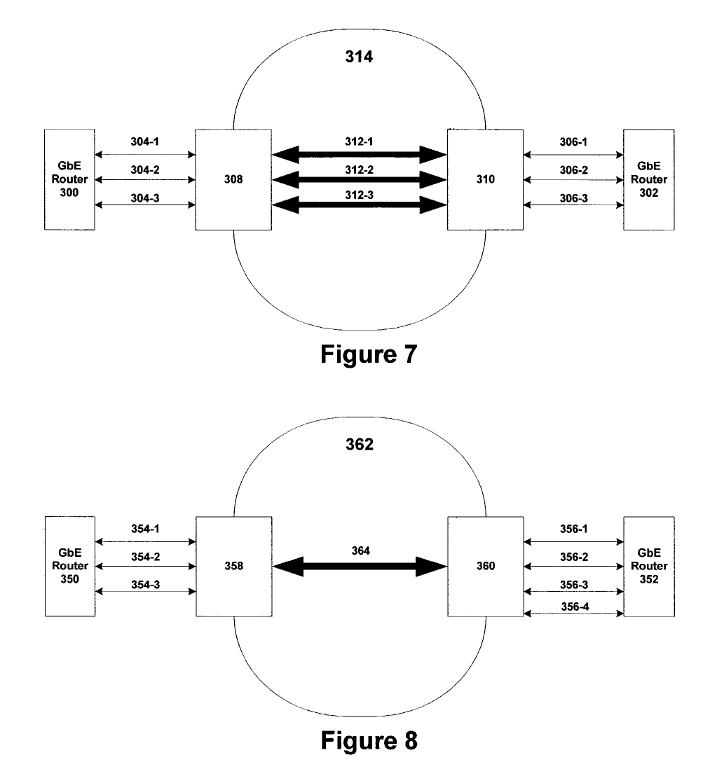

FIG. 7 illustrates an example of direct GbE to VC channel mapping in accordance with the illustrative embodiment of the present invention, based on which, VPL (Virtual Private Line) and Over Subscription service can be provided. As shown in FIG. 7, three GbE pipes are interconnected to an edge optical switch node 308 and 310 of SONET network 314 via a first GbE port 304-1, a second GbE port 304-2 and a third GbE port 304-3 on one end and a first GbE port 306-1, a second GbE port 306-2 and a third GbE port 306-3 on the other end. The GbE rate is provisioned according to VC channel bandwidth at STS-1 granularity. In FIG. 7, one VC channel is mapped to a GbE port and equal number of GbE ports are on both ends of the network. The optical nodes 304 and 306 can be an optical switch node such as SN16000 from Sycamore Networks, Inc. of Chelmsford, Mass., equipped with the interface disclosed in FIG. 3 (which supports STS-1 granularity).

VPL service between 300 and 302 can be provided by classifying, selecting and allocating the packets from three GbE ports 304-1, 304-2, and 304-3 to a first VC channel 312-1, a second VC channel 312-2 and a third VC channel 312-3 for signal flows from 300 to 302. The packets will be extracted and re-allocated onto GbE ports 306-1, 306-2 and 306-3 based on packet classification information and GbE port address information carried either by GFP or VCL. The signal flow from 302 to 300 is the same. Over-subscription (which refers to the ability of a single path to handle all of the ports connected to it at full load) can be provided in this embodiment. Conventionally in Ethernet, over-subscription is handled via approaches like backpressue applied to GbE equipment by 300 or 302 via means of pause frame, which in essence holds the Ethernet traffic on the whole GbE pipe although some of the traffic with higher COS requirement may need immediate service. The present invention is able to resolve this issue by selecting the packets with higher COS requirement and serve them first, the same backpressue mechanism will only be applied to traffic with lower priority.

The bandwidth of VC channels can also be adjusted dynamically by 300 and 302 via a constraint-based path selection algorithm based on client requirements and traffic flow control in granularity as low as VT 1.5 as long as optical switch nodes 300 and 302 support it.

The VC channels 312-1, 312-2 and 312-3 are setup through circuit switched SONET network 314 by optical switch node 300 or 302 via a constraint-based path selection algorithm. The constraint-based path selection algorithm is different from IP packet switched networks wherein packet forwarding is done on a hop-by-hop basis (no connection established ahead of time). The constraint-based path selection algorithm can take into consideration the packet classification information to enable the SONET circuit network to carry many popular GbE services such as VPL (Virtual Private Line), Statistical Multiplexing, VLAN, Selective Protection, Selective broadcast and multicast etc. which will be further described with details in following examples.

### EXAMPLE 2

FIG. 8 illustrates an example of aggregation of multiple GbE to a single VC channel application in accordance with the illustrative embodiment of the present invention. In contrast to FIG. 7, three GbE pipes via GbE ports 354-1, 354-2, 354-3 on one end and four GbE ports 356-1, 356-2, 356-3, 356-4 on the other end are mapped to one VC channel 364 by statistical multiplexing of the packets from different GbE ports. Similar to FIG. 7, over-subscription service can also be provided. The bandwidth of VC channel 364 can be adjusted incrementally in granularity as low as VT 1.5 or STS-1. The number of GbE ports on two ends may be different. By doing this, multiple GbE pipes can be combined to form a logical link so to provide link aggregation function.

### EXAMPLE 3

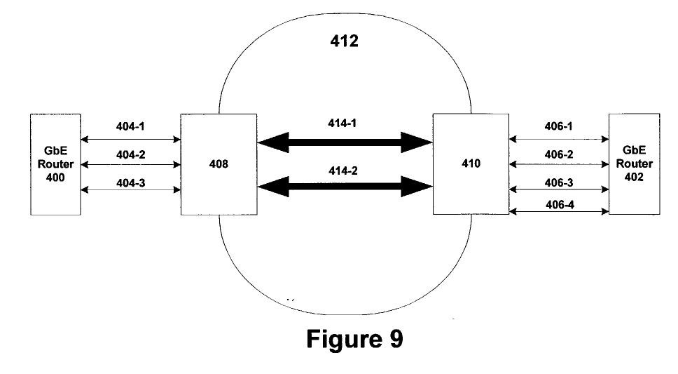

FIG. 9 illustrates an example of aggregation of multiple GbE to multiple VC channels in accordance with the illustrative embodiment of the present invention. As in FIG. 8, link aggregation and statistical multiplexing services can be provided. The packet classification can be based on client port ID, VLAN ID, VLAN priority field, DA/SA combination or even higher layer routing information like MPLS so to allocate traffic from GbE ports 404-1, 404-2, 404-3 on one end and 406-1, 406-2, 406-3, 406-4 on the other end to the first VC channel 414-1 and the second VC channel 414-2 for traffic flow from GbE to SONET direction. For SONET to GbE direction, as stated before, VCL, double VLAN tag or GFP fields can be used to map SONET traffic to appropriate GbE ports.

### EXAMPLE 4

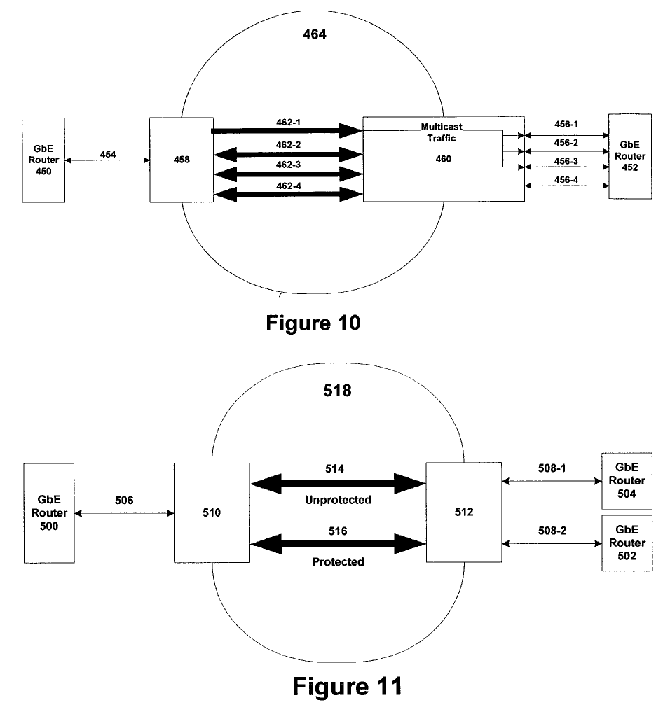

FIG. 10 illustrates an example of point to multipoint application of GbE over SONET in accordance with the present invention. One issue in handling broadcast and multicast traffic is to selectively broadcast and multicast traffic so that broadcast and multicast traffic wouldn't grab more bandwidth than necessary. As shown in FIG. 10, 4 VC channels 462-1 to 462-4 are setup through SONET networks 464 via optical switch node 458 and 460, wherein each VC channel carries traffic from GbE pairs between GbE router/switch 450 and 452, the traffic which needs to be broadcasted and multicasted can be classified and allocated to VC channel 462-1 and selectively sent to GbE ports 456-1, 456-2 and 456-3 so not every single traffic stream will be broadcasted and multicasted to every single GbE port. As usual, the packet classification can be based on client port ID, VLAN ID, VLAN priority field, DA/SA combination or even higher layer routing information like MPLS.

### EXAMPLE 5

FIG. 11 illustrates an example of selective protection service application in accordance with the present invention. Conventionally a GbE pipe will be carried over SONET as a whole, although it may contain traffic from different clients or same clients with different COS requirements. So it is hard to provide differentiated services to the clients. One such service is protection. By employing the embodiment as shown in FIG. 11, selective protection to the traffic carried in a single GbE pipe can be provided. Two VC channels 514 and 516 are setup through SONET networks 518 via optical switch nodes 510 and 512. These VC channels carry traffic from multiple GbE pairs between GbE router/switch 500 and 502, 504. The traffic which needs to be protected such as guarantee traffic can be classified and allocated to VC channel 516 and those traffic which do not need protection such as best effort traffic will be sent over to VC channel 514. The VC channel setup by the switch nodes 510 and 512 should make sure 514 and 516 are diversified so they will not share the common risk. The packet classification can be based on client port ID, VLAN ID, VLAN priority field, DA/SA combination.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved. It is intended that the present invention be limited only to the extent required by the appended claims and the applicable rules of law.

What is claimed is:

1. An interface for an optical node in a SONET/SDH optical network with a plurality of virtual concatenation channels, comprising:
a plurality of input ports for accepting Ethernet signals and a plurality of output ports for selectively outputting Ethernet frames in said Ethernet signals to said virtual concatenation channels, wherein said virtual concatenation channels are connected to said output ports.

2. The interface of claim 1, wherein the optical node is a switching node.

3. The interface of claim 1, further comprising an electrical interface for interconnecting physical layer device and a link layer device.

4. The interface of claim 1, further comprising a packet switching device and a SONET framer.

5. The interface of claim 3, wherein the electrical interface is compliant with the SPI4 (System Physical Interface Level 4) standard.

6. The interface of claim 3, wherein the electrical interface is compliant with the UTOPIA standard.

7. A method for processing a plurality of Ethernet input signals from an optical node in a SONET/SDH network having a plurality of virtual concatenation channels, comprising:
classifying Ethernet frames in said Ethernet input signals; and
allocating said classified Ethernet frames to said virtual concatenation channels.

8. The method of to claim 7 wherein bandwidths of said virtual concatenation channels can be hitlessly increased and decreased.

9. The method of to claim 7 wherein the number of said virtual concatenation channels can be hitlessly setup and torn down.

10. The method of to claim 7, wherein said step of classifying Ethernet frames classify Ethernet frames based on client port ID, VLAN (Virtual Local Area Network) ID in said Ethernet frames.

11. The method of to claim 7, wherein said step of classifying Ethernet frames classify Ethernet frames based on priority information in said Ethernet frames.

12. The method of claim 7, wherein said step of classifying Ethernet frames classifies Ethernet claims based on MPLS routing information.

13. The method of claim 7, wherein said step of classifying Ethernet frames classifies Ethernet frames based on class of service (COS) information.

14. The method of claim 7, wherein said step of classifying Ethernet frames classifies Ethernet frames based on protection information.

15. The method of claim 7, wherein said step of allocating Ethernet frames further includes mapping said Ethernet frames into a SONET frame.

16. The method of claim 15, wherein the mapping further includes the step of mapping Ethernet frames into a Generic Framing Procedure (GFP) frame.

17. The method of claim 15, wherein the mapping further includes the step of mapping Ethernet frames into High-Level Data Link Control (HDLC) frame.

18. A SONET/SDH optical network with a plurality of nodes interconnected to a plurality of Ethernet router/switches, comprising:
a first of the nodes for receiving a plurality of Ethernet signals from said Ethernet router/switches as inputs;
means for classifying and mapping Ethernet frames from said Ethernet signals to a plurality of virtual concatenation channels for transmitting on said network;
a second of the nodes interconnecting with said first node via said virtual concatenation channels for receiving said transmitted signals on said virtual concatenation channels;
means for processing and mapping said transmitted signals into Ethernet signals for outputting to said Ethernet router/switches.

19. The SONET/SDH optical network of claim 18, wherein the first of the nodesis an optical switch node with a plurality of input ports and a plurality of output ports.

20. The SONET/SDH optical network of claim 18, wherein said virtual concatenation channels are dedicated to clients identified by classifying the packets in Ethernet signals.

21. The SONET/SDH optical network of claim 18, wherein said means for classifying and mapping Ethernet frames classifies by statistically multiplexing Ethernet packets.

22. The SONET/SDH optical network of claim 18, wherein said means for classifying and mapping Ethernet frames selectively sends Ethernet packets to a group of Ethernet ports in a VLAN via virtual concatenation channels.

23. The SONET/SDH optical network of claim 18, wherein, means for classifying and mapping Ethernet frames sends broadcast and multicast packets identified via said classification methods to a group of dedicated Ethernet ports via dedicated virtual concatenation channels.

24. The SONET/SDH optical network of claim 18, wherein said means for classifying and mapping Ethernet frames selectively sends classified Ethernet packets to a protected virtual concatenation channel.

25. The SONET/SDH optical network of claim 18, wherein said means for classifying and mapping Ethernet frames applies standard Ethernet backpressure to a first group of selected packets via said classification methods and sends a second group of selected packets via said virtual concatenation channels.

26. The SONET/SDH optical network of claim 18, wherein said means for processing and mapping said transmitted signals into Ethernet signals is based on VCL.

27. The SONET/SDH optical network of claim 18, wherein means for processing and mapping said transmitted signals into Ethernet signals uses GFP frame information to process and map said transmitted signals.
